(19) United States
(12) Patent Application Publication
(10) Pub. No.: US 2006/0103619 A1
(43) Pub. Date: May 18, 2006

(54) Driving unit and display apparatus having the same

(76) Inventor: Young-Ki Kim, Hwaseong-si (KR)

Correspondence Address: CANTOR COLBURN, LLP, 55 GRIFFIN ROAD SOUTH, BLOOMFIELD, CT, 06002, US

(21) Appl. No.: 11/216,925

(22) Filed: Aug. 31, 2005

(30) Foreign Application Priority Data
Aug. 31, 2004 (KR) 10-2004-0068814

(51) Int. Cl. G09G 3/36

(52) U.S. Cl. 345/98

(57) ABSTRACT

In a driving unit and a display apparatus having the driving unit, a control part outputs a first control signal, a second control signal, and a gamma reference voltage in response to an external signal and a data driver outputs a data voltage in response to the first control signal. An amplifier amplifies the second control signal from the control part and outputs a third control signal, and a gate driver sequentially outputs a plurality of gate voltages in response to the third control signal. A method for preventing malfunction of a driving unit in a display apparatus due to a distortion in gate voltage includes amplifying a control signal sent to the gate driver. Accordingly, the display apparatus may prevent malfunction thereof caused by distortion of the gate voltages.

This application claims priority to Korean Patent Application No. 2004-68814, filed on Aug. 31, 2004 and all the benefits accruing therefrom under 35 U.S.C. §119, and the contents of which in its entirety are herein incorporated by reference.

### BACKGROUND OF THE INVENTION

1. Field of the Invention

The present invention relates to a driving unit and a display apparatus having the driving unit. More particularly, the present invention relates to a driving unit capable of preventing malfunction thereof and a display apparatus having the driving unit.

2. Description of the Related Art

In general, a liquid crystal display apparatus includes a liquid crystal display panel for displaying an image, and further includes data and gate drivers driving the liquid crystal display panel. The liquid crystal display panel has a lower substrate, an upper substrate facing the lower substrate and a liquid crystal layer disposed between the lower and upper substrates. The lower substrate has a plurality of data lines and a plurality of gate lines formed thereon. The data lines and the gate lines cross over each other with respect to the lower substrate, but are insulated from each other such as by an insulating layer.

A data driver applies a data voltage to the data lines and a gate driver applies a gate voltage to the gate lines.

The liquid crystal display apparatus may have various structures in accordance with varying shapes and/or mounting positions of the data and gate drivers. When the data and gate drivers are formed in a chip type, the data and gate drivers are mounted on the liquid crystal display panel or a film attached to the liquid crystal display panel.

In a structure wherein the data and gate drivers are mounted on the film, the liquid crystal display apparatus has a data tape carrier package (“TCP”) and a gate TCP, wherein such a film is flexible. The data and gate drivers formed in the chip type are mounted on the data and gate TCPs, respectively.

The liquid crystal display apparatus further includes a data printed circuit board and a gate printed circuit board electrically connected to the liquid crystal display panel through the data and gate TCPs, respectively. The data and gate printed circuit boards include a data controller and a gate controller, respectively. The data and gate controllers output control signals to control the data and gate drivers, respectively.

Recently, a technology that integrates the data and gate drivers into one printed circuit board has been developed, so that the data and gate drivers may be controlled through one controller. The integrated printed circuit board is electrically connected to the liquid crystal display apparatus and the controller through the data and gate TCPs, respectively.

The integrated printed circuit board further includes an interface for data communication between the controller and an external device. The liquid crystal display apparatus has a transistor-transistor logic (“TTL”) interface as the interface for the data communication between the controller and the external device. A voltage level applied to the liquid crystal display panel through the TTL interface has a standardized voltage level of about 3.3 volts.

When the gate driver is driven using a low voltage signal of about 3.3 volts, the data driver outputs the gate voltage having a voltage level of about 3.3 volts. With the data lines and the gate lines crossing over each other and insulated from each other as described above, a parasitic capacitance is generated between the data lines and the gate lines. The gate voltage is vulnerable to the parasitic capacitance because the gate voltage is maintained in a low voltage level of about 3.3 volts. As a result, the liquid crystal display apparatus may malfunction due to the gate voltage.

### BRIEF SUMMARY OF THE INVENTION

The present invention provides a driving unit capable of preventing malfunction thereof.

The present invention also provides a display apparatus having the above driving unit.

In exemplary embodiments of a driving unit, the driving unit includes a control part, a data driver, an amplifier, and a gate driver. The control part outputs a first control signal, a second control signal, and a gamma reference voltage in response to an external signal. The data driver outputs a data voltage in response to the first control signal. The amplifier amplifies the second control signal from the control part, and outputs a third control signal. The gate driver sequentially outputs a plurality of gate voltages in response to the third control signal.

In exemplary embodiments of a display apparatus, the display apparatus includes a display panel and a driving unit. The driving unit includes a control part, a data driver, an amplifier, and a gate driver.

The display panel has a plurality of gate lines and a plurality of data lines to display an image in response to a gate voltage and a data voltage. The plurality of data lines and the plurality of gate lines cross over each other within the display panel and are insulated from each other.

The control part outputs a first control signal, a second control signal, and a gamma reference voltage in response to an external signal.

The data driver is electrically connected to the data lines to supply the data voltage to the data lines in response to the first control signal.

The amplifier amplifies the second control signal from the control part, and outputs a third control signal.

The gate driver is electrically connected to the gate lines to sequentially output the gate voltage to the gate lines in response to the third control signal.

In another exemplary embodiment, a method of preventing malfunction of a driving unit in a display apparatus due to a distortion in gate voltage includes sending a control signal from a control part to an amplifier, amplifying the control signal in the amplifier, outputting an amplified control signal from the amplifier, sending the amplified control signal from the amplifier to a gate driver, and outputting at least one gate voltage from the gate driver in response to the amplified control signal.

According to the above-described embodiments, the driving unit further includes the amplifier to amplify the signal applied to the gate driver, so that the driving unit may prevent distortion of the gate voltage outputted from the gate driver and may therefore prevent malfunction of the display apparatus containing the driving unit.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram showing an exemplary embodiment of a driving unit;

FIG. 2 is a schematic diagram showing the exemplary amplifier in FIG. 1;

FIG. 3 is an exemplary input-output waveform diagram of the amplifier shown in FIG. 2;

FIG. 4 is a block diagram showing another exemplary embodiment of an amplifier;

FIG. 5 is a plan view showing an exemplary embodiment of a display apparatus;

FIG. 6 is a partially enlarged plan view of a portion “A” in FIG. 5;

FIG. 7 is a partially enlarged plan view showing another exemplary embodiment of a display apparatus; and

FIG. 8 is a plan view showing another exemplary embodiment of a display apparatus.

### DETAILED DESCRIPTION OF THE INVENTION

Hereinafter, the present invention will be explained in detail with reference to the accompanying drawings. In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

FIG. 1 is a block diagram showing an exemplary embodiment of a driving unit. Referring to FIG. 1, a driving unit 100 includes a control part 110, a data driver 120, an amplifier 130, and a gate driver 140.

The control part 110 receives an external signal ES and outputs a first control signal, a second control signal, and a gamma reference voltage VGMMA. The VGMMA is a reference to generate a liquid crystal driving voltage. In the exemplary embodiments described herein, the control part 110 includes a timing controller, a DC-DC converter, and a gray-scale voltage generator. The timing controller processes the external signal ES for generating driving signals. The DC-DC converter may control a duty ratio, so that a constant DC voltage will be output. If an output DC voltage is above a predetermined value, the duty ratio is reduced, to thereby lower the output DC voltage, and if an output DC voltage is below the predetermined value, the duty ratio is increased, to thereby increase the output DC voltage.

The gray-scale voltage generator generates a gray-scale voltage in response to the gamma reference voltage VGMMA. The data driver 120 outputs a data voltage Vd in response to the first control signal and the gray-scale voltage from the gray-scale voltage generator. The amplifier 130 receives the second control signal and amplifies the received second control signal to output a third control signal with amplified voltage. The gate driver 140 sequentially outputs a first gate voltage Vg1 to an n-th gate voltage Vgn through a plurality of output terminals in response to the third control signal.

The “n” is a natural number more than “1”.

The first control signal includes a horizontal start signal STH starting an operation of the data driver 120 and an analog driving voltage AVDD from the DC-DC converter. The second control signal includes a vertical start signal STV starting an operation of the gate driver 140, a first clock signal CPV1 deciding shift timings of the first gate voltage Vg1 to the n-th gate voltage Vgn outputted from the gate driver 140, and a first output enable signal OE1 defining high periods of the first gate voltage Vg1 to an n-th gate voltage Vgn outputted from the gate driver 140 so that there is a phase difference with respect to each other.

The first clock signal CPV1 and the first output enable signal OE1 are amplified by the amplifier 130 into the second clock signal CPV2 and a second output enable signal OE2, respectively. The second clock signal CPV2 and the second output enable signal OE2 are applied to the gate driver 140. The vertical start signal STV may be directly applied to the gate driver 140.

In FIG. 1, since the vertical start signal STV is used only to start the gate driver 140, the vertical start signal STV may be directly applied to the gate driver 140, as in the illustrated embodiment, without amplification of the vertical start signal STV. That is, the vertical start signal STV need not pass through the amplifier 130 before being applied to the gate driver 140. However, the driving unit 100 may instead apply an amplified vertical start signal to the gate driver 140 by first passing the vertical start signal STV through the amplifier 130.

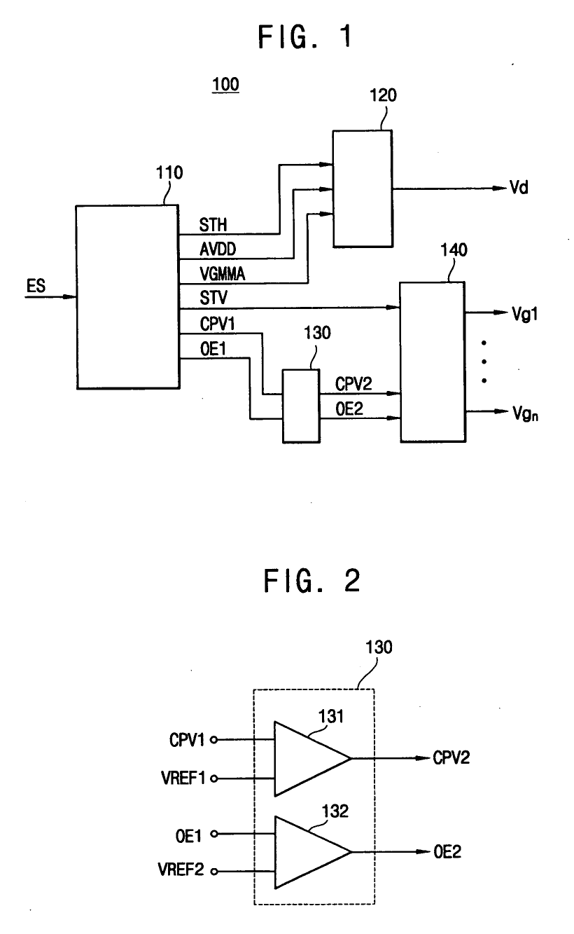

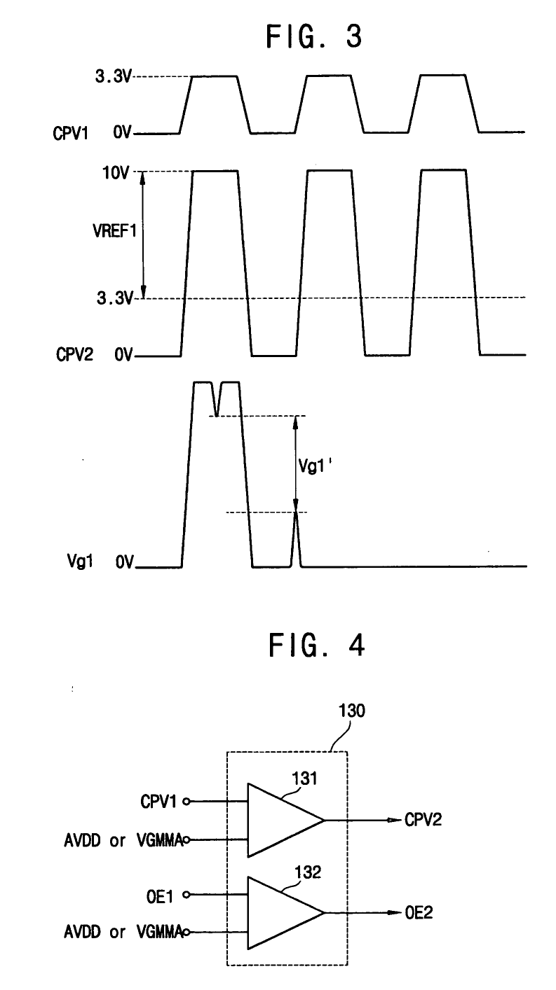

Hereinafter, the amplifier 130 will be described in detail with reference to FIGS. 2 and 3.

FIG. 2 is a schematic diagram showing the amplifier 130 of FIG. 1. FIG. 3 is an exemplary input-output waveform diagram of the amplifier 130 shown in FIG. 2.

Referring to FIG. 2, the amplifier 130 has a first operational amplifier 131 and a second operational amplifier 132.

The first operational amplifier 131 receives the first clock signal CPV1 and a first reference signal VREF1 to output the second clock signal CPV2 amplified by the first reference signal VREF1. The second operational amplifier 132 receives the first output enable signal OE1 and a second reference signal VREF2 to output the second output enable signal OE2 amplified by the second reference signal VREF2. The first and second reference signals VREF1 and VREF2 are provided by the control part 110.

As shown in FIG. 3, the first clock signal CPV1 swings between zero and 3.3 volts and the second clock signal CPV2 swings between zero and 10 volts when amplified by the first reference signal VREF1.

The gate driver 140 outputs the first gate voltage Vg1 to the n-th gate voltage Vgn in response to the second clock signal CPV2. For example, the first gate voltage Vg1 is generated during a logic high period and the first gate voltage Vg1 has a voltage level of about 10 volts. Thus, although the first gate voltage Vg1 is distorted by a noise, as demonstrated in the waveform diagram, over 3.3 volts of an effective first gate voltage Vg1′ from which the noise is removed may still be obtained, thus preventing a malfunction of the liquid display apparatus due to gate voltage distortion.

FIG. 4 is a block diagram showing another exemplary embodiment of an amplifier.

Referring to FIG. 4, amplifier 130 includes a first operational amplifier 131 and a second operational amplifier 132. The first operational amplifier 131 receives the first clock signal CPV1 from the control part 110, as shown in FIG. 1, through a first input terminal thereof and an analog driving voltage AVDD or the gamma reference voltage VGMMA from the control part 110, such as the analog driving voltage AVDD and the gamma reference voltage VGMMA applied to the data driver 120 from the control part 110 in FIG. 1, through a second input terminal thereof. The second operational amplifier 132 receives the first output enable signal OE1 from the control part 110, as shown in FIG. 1, through a first input terminal thereof and the analog driving voltage AVDD or the gamma reference voltage VGMMA from the control part 110 through a second input terminal thereof.

Thus, the first operational amplifier 131 amplifies the first clock signal CPV1 to output the second clock signal CPV2 amplified by the analog driving voltage AVDD or the gamma reference voltage VGMMA. The second operational amplifier 132 amplifies the first output enable signal OE1 to output the second output enable signal OE2 amplified by the analog driving voltage AVDD or the gamma reference voltage VGMMA.

The analog driving voltage AVDD and the gamma reference voltage VGMMA are outputted from the control part 110 and used to drive the data driver 120. The analog driving voltage AVDD and the gamma reference voltage VGMMA are a direct current voltage.

In one exemplary embodiment, the analog driving voltage AVDD has a voltage level of about 12 volts. Thus, the second clock signal CPV2 and the second output enable signal OE2 are amplified by 12 volts in comparison with the first clock signal CPV1 and the first output enable signal OE1, respectively.

Although not shown in FIGS. 2 and 4, the amplifier 130 may further include a third operational amplifier so as to amplify the vertical start signal STV.

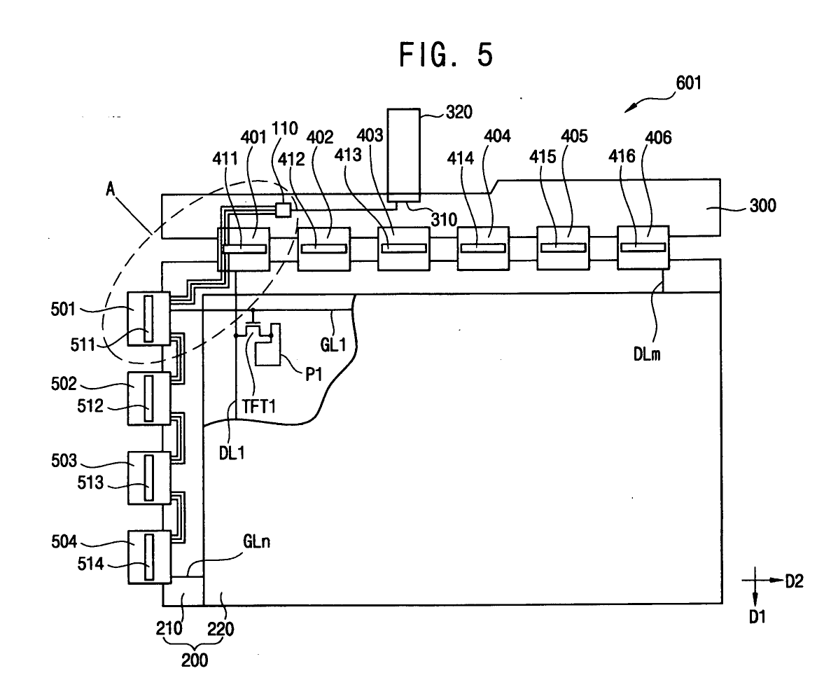

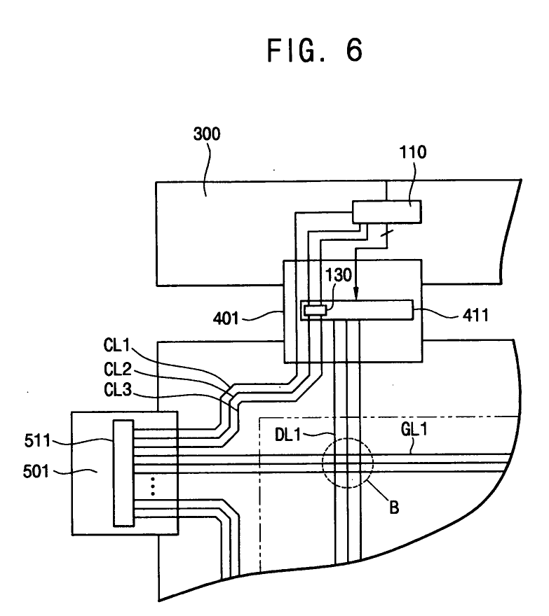

FIG. 5 is a plan view showing an exemplary embodiment of a display apparatus. FIG. 6 is a partially enlarged plan view of a portion “A” in FIG. 5.

Referring to FIGS. 5 and 6, a display apparatus 601 includes a display panel 200 displaying an image and the driving unit 100 (FIG. 1) driving the display panel 200.

The display panel 200 includes a first display substrate 210, a second display substrate 220 facing the first display substrate 210, and a liquid crystal layer disposed between the first and second display substrates 210 and 220.

The first display substrate 210 has a first data line DL1 to an m-th data line DLm and a first gate line GL1 to an n-th gate line GLn. The first to m-th data lines DL1 to DLm are extended in a first direction D1 and the first to n-th gate lines GL1 to GLn are extended in a second direction D2 substantially perpendicular to the first direction D1. First direction D1 may be substantially perpendicular to a first end of the display panel 200 and substantially parallel to a second end of the display panel 200, where the first end and the second are perpendicular to each other. Likewise, the direction D2 may be substantially perpendicular to a second end of the display panel 200 and substantially parallel to a first end of the display panel 200. In the present embodiment, “n” and “m” are natural numbers more than “1”. The first to m-th data lines DL1 to DLm and the first to n-th gate lines GL1 to GLn overlap each other, as exemplified by a portion “B” of FIG. 6, yet are insulated from each other. In one exemplary embodiment, a gate insulating layer (not shown) may be formed on the first display substrate 210 containing the gate lines GL1 to GLn and the data lines DL1 to DLm may be formed on the gate insulating layer.

The first display substrate 210 further includes a plurality of thin film transistors (“TFTs”), for controlling signals to be applied to pixel electrodes, and a plurality of the pixel electrodes, for receiving signals depending on the switching of the TFTs. The first data line DL1 is connected to a source electrode of a first thin film transistor TFT1, the first gate line GL1 is connected to a gate electrode of the first thin film transistor TFT1 and a first pixel electrode P1 is connected to a drain electrode of the first thin film transistor TFT1.

Although not shown in FIGS. 5 and 6, the second display substrate 220 has a color filter layer having red, green and blue color pixels and a common electrode facing the pixel electrodes.

The driving unit 100 includes the control part 110, the data driver 120, the amplifier 130, and the gate driver 140. In FIGS. 5 and 6, the same reference numerals denote the same elements in FIG. 1, and thus the detailed descriptions of the driving unit 100 will be omitted.

The display apparatus 601 further includes a printed circuit board 300, first to sixth data TCPs 401, 402, 403, 404, 405 and 406 and first to fourth gate TCPs 501, 502, 503 and 504. The first to sixth data TCPs 401, 402, 403, 404, 405 and 406 are arranged along the first end of the display panel 200, and the first to fourth gate TCPs 501, 502, 503 and 504 are arranged along the second end of the display panel 200. The control part 110 formed in the chip type is mounted on the printed circuit board 300. The printed circuit board 300 is arranged adjacent to the first end of the display panel 200, and spaced from the first end of the display panel 200 by the first to sixth data TCPs 401, 402, 403, 404, 405 and 406.

The first to sixth data TCPs 401, 402, 403, 404, 405 and 406 are disposed between the printed circuit board 300 and the first end of the display panel 200 to electrically connect the printed circuit board 300 to the display panel 200. The first to fourth gate TCPs 501, 502, 503 and 504 are attached to the second end of the display panel 200.

The data driver 120 includes first to sixth data driving chips 411, 412, 413, 414, 415 and 416, and the gate driver 140 includes first to fourth gate driving chips 511, 512, 513 and 514. The first to sixth data driving chips 411, 412, 413, 414, 415 and 416 are mounted on the first to sixth data TCPs 401, 402, 403, 404, 405 and 406, respectively. The first to fourth gate driving chips 511, 512, 513 and 514 are mounted on the first to fourth gate TCPs 501, 502, 503 and 504, respectively.

The gate driver 140, which includes the first to fourth gate driving chips 511, 512, 513 and 514, is electrically connected to the control part 110 mounted on the printed circuit board 300 through the first data TCP 401. The first gate driving chip 511 is nearest to the printed circuit board 300, that is, the first gate driving chip 511 is closest to the corner of the display panel 200 formed between the first and second ends of the display panel 200. The first gate driving chip 511 is thus electrically connected to the control part 110 through first, second and third connection lines CL1, CL2, and CL3 formed on the first data TCP 401 and the display panel 200. Furthermore, the first to fourth gate driving chips 511, 512, 513 and 514 are electrically connected to each other through the first, second, and third connection lines CL1, CL2, and CL3 and an adjacent gate driving chip thereto. That is, the connection lines CL1, CL2, and CL3 extend from the first gate driving chip 511 to the second gate driving chip 512, from the second gate driving chip 512 to the third gate driving chip 513, and from the third gate driving chip 513 to the fourth gate driving chip 514.

The amplifier 130 is disposed in the first data driving chip 411 that is nearest to the gate driver 140. That is, the first data driving chip 411 is closest to the corner of the display panel 200 formed between the first and second ends of the display panel 200, and this is the data driving chip that is closest to the gate driver 140 arranged along the second end of the display panel 200. As previously described, the amplifier 130 amplifies the first clock signal CPV1 and the first output enable signal OE1 outputted from the control part 110 to output the second clock signal CPV2 and the second output enable signal OE2.

The second clock signal CPV2 outputted from the amplifier 130 is applied to the first to fourth gate driving chips 511, 512, 513 and 514 through the second connection line CL2, and the second output enable signal OE2 is applied to the first to fourth gate driving chips 511, 512, 513 and 514 through the third connection line CL3. Also, the vertical start signal STV outputted from the control part 110 is applied to the first to fourth gate driving chips 511, 512, 513 and 514 through the first connection line CL1.

The printed circuit board 300 has an interface 310 for data communication between an external device (not shown) and the control part 110. The interface 310 is electrically connected to the external device through a flexible film 320. In general, a signal provided through the TTL interface has the voltage level of about 3.3 volts. Thus, in a case where the low voltage interface such as the TTL interface is used for the display apparatus 601, the amplifier 130 is necessary to drive the gate driver 140.

Referring to FIGS. 3 and 5, although the first clock signal CPV1 provided from the external device has the voltage level of about 3.3 volts, the gate driver 140 outputs the first gate voltage Vg1 having a voltage level of about 10 volts in response to the second clock signal CPV2. Thus, although the first gate voltage Vg1 is distorted by noise, over 3.3 volts of the effective first gate voltage Vg1′, from which the noise is removed, may be obtained, thereby preventing malfunction of the gate driver 140.

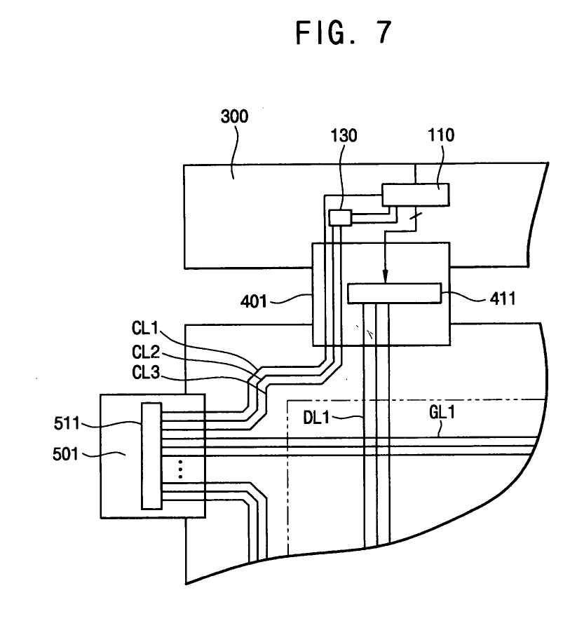

FIG. 7 is a partially enlarged plan view showing another exemplary embodiment of a display apparatus. In FIG. 7, the same reference numerals denote the same elements in FIG. 6, and thus the detailed descriptions of the same elements will be omitted.

Referring to FIG. 7, the amplifier 130 amplifies the first clock signal CPV1 and the first output enable signal OE1 outputted from the control part 110 to output the second clock signal CPV2 and the second output enable signal OE2, respectively. In this embodiment, the amplifier 130 and the control part 110 are mounted on the printed circuit board 300. The amplifier 130 is mounted outside of the first data driving chip 411, instead of within the first data driving chip 411 as in the embodiment illustrated in FIG. 6.

Thus, the second clock signal CPV2 outputted from the amplifier 130 is applied to the first and fourth driving chips 511, 512, 513 and 514 through the first data TCP 401 that is nearest to the gate driver 140 and through the second connection line CL2 formed at the display panel 200. The second output enable signal OE2 is applied to the first to fourth gate driving chips 511, 512, 513 and 514 through the first data TCP 401 and through the third connection line CL3 formed at the display panel 200. The vertical start signal STV outputted from the control part 110 is applied to the first to fourth driving chips 511, 512, 513 and 514 through the first connection line CL1.

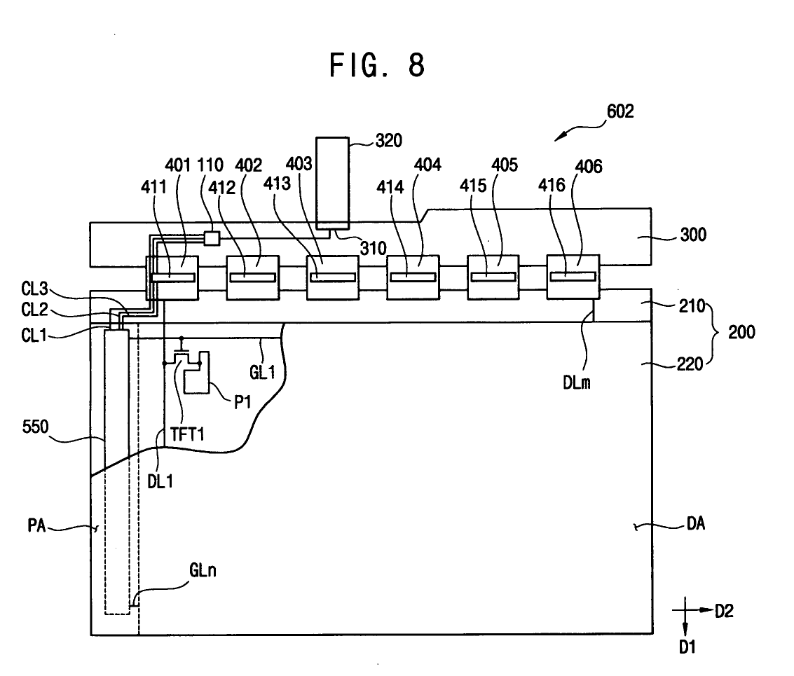

FIG. 8 is a plan view showing another exemplary embodiment of a display apparatus. In FIG. 8, the same reference numerals denote the same elements in FIG. 5, and thus the detailed descriptions of the same elements will be omitted.

Referring to FIG. 8, a display apparatus 602 includes the display panel 200, the driving unit 100, the printed circuit board 300, and the first to sixth data TCPs 401, 402, 403, 404, 405 and 406. The driving unit 100 includes the control part 110, the data driver 120, the amplifier 130, and the gate driver 140.

The control part 110 is formed in the chip type and mounted on the printed circuit board 300. The data driver 120 has the first to sixth data driving chips 411, 412, 413, 414, 415 and 416 mounted on the first to sixth data TCPs 401, 402, 403, 404, 405 and 406, respectively. The amplifier 130 is disposed in the first data driving chip 411.

The amplifier 130 amplifies the first clock signal CPV1 outputted from the control part 110 to output the second clock signal CPV2. The amplifier 130 also amplifies the first output enable signal OE1 to output the second output enable signal OE2.

The gate driver 140 includes one shift register 550 and is disposed inside the display panel 200, adjacent the second end of the display panel 200. The shift register 550 may include a series of cascade-connected stages, where each stage outputs a gate signal in response to a driving signal.

The display panel 200 has the first display substrate 210, the second display substrate 220 facing the first display substrate 210 and the liquid crystal layer (not shown) disposed between the first and second display substrates 210 and 220. The first display substrate 210 has a first data line to an m-th data line DL1 to DLm, a first gate line to an n-th gate line GL1 to GLn, the TFTs, and the pixel electrodes.

The shift register 550 includes a plurality of transistors (not shown), so that the shift register 550 is formed in a peripheral area PA of the first display substrate 210 while the thin film transistors are formed in a display area DA of the first display substrate 210.

The shift register 550 receives the vertical start signal STV from the control part 110. The shift register 550 sequentially outputs the gate voltage to the first to n-th gate lines GL1 to GLn in response to the second clock signal CPV2 and the second output enable signal OE2. The second clock signal CPV2, the second output enable signal OE2, and the vertical start signal STV may be passed to the shift register 550 through the first data TCP 401, and through the connection lines CL2, CL3, and CL1, respectively.

A method of preventing malfunction of a driving unit in a display apparatus due to a distortion in gate voltage is made possible using the above described embodiments of a driving unit. The method may include, in part, sending a control signal from the control part 110 to the amplifier 130, amplifying the control signal in the amplifier 130, outputting an amplified control signal from the amplifier 130, sending the amplified control signal from the amplifier 130 to the gate driver 140, and outputting at least one gate voltage Vg from the gate driver 140 in response to the amplified control signal.

The method may further include positioning the amplifier 130 within the data driver 120.

The method may further include sending a first control signal from the control part 110 to the data driver 120 and outputting at least one data voltage Vd from the data driver 120 in response to the first control signal.

Amplifying the control signal in the amplifier 130 may include amplifying the control signal by a reference signal such that an effective gate voltage Vg′ of the at least one gate voltage Vg is greater than a noise distorting the at least one gate voltage Vg.

Wherein the amplifier includes a first operational amplifier 131 and a second operational amplifier 132, the method further includes sending a first clock signal and a reference signal to the first operational amplifier 131, amplifying the first clock signal by the reference signal in the first operational amplifier 131 to output a second clock signal, sending a first output enable signal and a reference signal to the second operational amplifier 132, and amplifying the first output enable signal by the reference signal in the second operational amplifier 132 to output a second output enable signal.

Other methods for utilizing the above-described driving unit and the display apparatus would also be within the scope of these embodiments.

According to the above-described exemplary embodiments of the driving unit and the display apparatus having the driving unit, the driving unit includes the amplifier amplifying the first clock signal and the first output enable signal to output the second clock signal and the second output enable signal, respectively. The amplified second clock signal and the amplified second output enable signal are applied to the gate driver.

Thus, the gate driver outputs the amplified gate voltage in response to the amplified second clock signal and the amplified second output enable signal. Therefore, although the gate voltage is distorted by noise, the display apparatus may prevent the malfunction thereof.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A driving unit comprising:
a control part receiving an external signal and outputting a first control signal, a second control signal and a gamma reference voltage in response to the external signal;
a data driver receiving the first control signal and outputting a data voltage in response to the first control signal;
an amplifier receiving the second control signal and amplifying the second control signal from the control part and outputs a third control signal; and
a gate driver receiving the third control signal and sequentially outputting a plurality of gate voltages in response to the third control signal.

2. The driving unit of claim 1, wherein the second control signal comprises:
a start signal to start an operation of the gate driver;
a first clock signal to control a shift timing of the gate voltages; and
a first output enable signal to define high periods of the gate voltages so that the gate voltages have a phase difference with respect to each other.

3. The driving unit of claim 2, wherein the amplifier comprises:
a first operational amplifier that receives the first clock signal and a first reference signal, wherein the first operational amplifier outputs a second clock signal amplified by the first reference signal; and
a second operational amplifier that receives the first output enable signal and a second reference signal, wherein the second operational amplifier outputs a second output enable signal amplified by the second reference signal.

4. The driving unit of claim 3, wherein the first control signal comprises an analog driving voltage to drive the data driver,
wherein each of the first and second reference signals received by the first and second operational amplifiers comprises the analog driving voltage.

5. The driving unit of claim 3, wherein each of the first and second reference signals received by the first and second operational amplifiers comprises the gamma reference voltage.

6. The driving unit of claim 1, wherein the amplifier is disposed within the data driver.

7. A display apparatus comprising:
a display panel to display an image in response to a gate voltage and a data voltage, the display panel having a plurality of gate lines and a plurality of data lines, wherein the data lines cross over the gate lines and wherein the data lines and the gate lines are insulated from each other;
a control part receiving an external signal and outputting a first control signal, a second control signal, and a gamma reference voltage in response to the external signal;
a data driver receiving the first control signal and supplying the data voltage to the data lines in response to the first control signal, the data driver being electrically connected to the data lines;
an amplifier receiving the second control signal and amplifying the second control signal from the control part and outputs a third control signal; and
a gate driver arranged receiving the third control signal and sequentially outputting the gate voltage to the gate lines in response to the third control signal, the gate driver being electrically connected to the gate lines.

8. The display apparatus of claim 7, further comprising:
a printed circuit board, wherein the control part is disposed on the printed circuit board;
a plurality of first flexible films connected between a first end of the printed circuit board and a first end of the display panel to electrically connect the printed circuit board to the display panel; and
a plurality of second flexible films attached to a second end of the display panel.

9. The display apparatus of claim 8, wherein the data driver comprises a plurality of data driving chips, and the data driving chips are mounted on the plurality of first flexible films, respectively.

10. The display apparatus of claim 9, wherein the gate driver comprises a plurality of gate driving chips, and the gate driving chips are mounted on the plurality of second flexible films, respectively.

11. The display apparatus of claim 10, wherein the amplifier is disposed in a first data driving chip in the plurality of data driving chips, and the first data driving chip is positioned nearest to the gate driver among the plurality of data driving chips.

12. The display apparatus of claim 8, wherein the amplifier is mounted on the printed circuit board.

13. The display apparatus of claim 7, wherein the second control signal comprises:
a start signal to start an operation of the gate driver;
a first clock signal to control a shift timing of the gate voltages; and
a first output enable signal to define high periods of the gate voltages so that the gate voltages have a phase difference with respect to each other.

14. The display apparatus of claim 13, wherein the amplifier comprises:
a first operational amplifier that receives the first clock signal and a first reference signal, wherein the first operational amplifier outputs a second clock signal amplified by the first reference signal; and
a second operational amplifier that receives the first output enable signal and a second reference signal, wherein the second operational amplifier outputs a second output enable signal amplified by the second reference signal.

15. The display apparatus of claim 14, wherein the first control signal comprises an analog driving voltage to drive the data driver,
wherein each of the first and second reference signals received by the first and second operational amplifiers comprises the analog driving voltage.

16. The display apparatus of claim 14, wherein each of the first and second reference signals received by the first and second operational amplifiers comprises the gamma reference voltage.

17. The display apparatus of claim 14, wherein the display panel further comprises:
a start signal line applying the start signal outputted from the control part to the gate driver;
a clock signal line applying the second clock signal outputted from the first operational amplifier to the gate driver; and
an output enable signal line applying the second output enable signal outputted from the second operational amplifier to the gate driver.

18. The display apparatus of claim 7, wherein the display panel comprises:
a first display substrate having the data lines and the gate lines formed thereon; and
a second display substrate coupled to the first display substrate.

19. The display apparatus of claim 18, wherein the first display substrate comprises:
a switching device electrically connected to the data lines and the gate lines; and
a pixel electrode coupled to an output terminal of the switching device.

20. The display apparatus of claim 18, wherein the gate driver is formed on the first display substrate.

21. The display apparatus of claim 7, further comprising an interface that provides data communication between the control part and an external device.

22. The display apparatus of claim 21, wherein the interface is a transistor-transistor logic interface.

23. A method of preventing malfunction of a driving unit in a display apparatus due to a distortion in gate voltage, the driving unit including a control part, an amplifier, and a gate driver, the method comprising:
sending a control signal from the control part to the amplifier;
amplifying the control signal in the amplifier;
outputting an amplified control signal from the amplifier;
sending the amplified control signal from the amplifier to the gate driver; and,
outputting at least one gate voltage from the gate driver in response to the amplified control signal.

24. The method of claim 23, wherein the driving unit further includes a data driver, the method further comprising positioning the amplifier within the data driver.

25. The method of claim 23, wherein the driving unit further includes a data driver, and the control signal is a second control signal, the method further comprising:
sending a first control signal from the control part to the data driver; and,
outputting at least one data voltage from the data driver in response to the first control signal.

26. The method of claim 23, wherein amplifying the control signal in the amplifier comprises amplifying the control signal by a reference signal, and an effective gate voltage of the at least one gate voltage is greater than a noise distorting the at least one gate voltage.

27. The method of claim 23, wherein the amplifier includes a first operational amplifier and a second operational amplifier, the method further comprising:
sending a first clock signal and a reference signal to the first operational amplifier;
amplifying the first clock signal by the reference signal in the first operational amplifier to output a second clock signal;
sending a first output enable signal and a reference signal to the second operational amplifier; and,
amplifying the first output enable signal by the reference signal in the second operational amplifier to output a second output enable signal.
